(19) United States
(12) Patent Application Publication
(10) Pub. No.: US 2018/0308036 A1
(43) Pub. Date: Oct. 25, 2018

(54) MITIGATING ABSENCE OF SKILL INPUT DURING COLLABORATION SESSION

(71) Applicant: MICROSOFT TECHNOLOGY LICENSING, LLC, Redmond, WA (US)

(72) Inventors: Chandra Sekhar ANNAMBHOTLA, Hyderabad (IN); Varun KHANNA, Hyderabad (IN)

(73) Assignee: MICROSOFT TECHNOLOGY LICENSING, LLC, Redmond, WA (US)

(21) Appl. No.: 15/496,096

(22) Filed: Apr. 25, 2017

(51) Int. Cl. G06Q 10/06; G06Q 10/10; H04L 29/06; H04L 29/08

(52) U.S. Cl. CPC G06Q 10/063112; G06Q 10/103; H04L 65/1089; H04L 67/22; H04L 65/1093

(57) ABSTRACT

Variety of approaches to mitigate an absence of a skill input during a collaboration session are described. A collaboration service detects a demand for the skill input associated with the collaboration session based on a behavior analysis of participant(s) of the collaboration session. Next, a multi-level search is performed for a person capable of providing the skill input. Upon locating the person capable of providing the skill input, a contact option for the person is identified. The contact option for the person is provided to the collaboration session.

### BACKGROUND

Information exchange have changed processes associated work and personal environments. Automation and improvements in processes have expanded scope of capabilities offered for personal and business data consumption. With the development of faster and smaller electronics, execution of mass processes at cloud systems have become feasible. Indeed, applications provided by data centers, data warehouses, data workstations have become common features in modern personal and work environments. Collaboration service(s) provide a wide variety of applications ranging from communication and document sharing applications that enable participation during a collaboration session.

Increasingly, cloud based resources are utilized for variety of services that include communication services, and/or document sharing services among others that facilitate participation in collaboration session(s). However, there are currently substantial gaps in mitigating lack of resource(s) that may be in demand during a collaboration session. Personnel resources are unnecessarily consumed for searching, finding, monitoring, and providing resource(s) in demand during a collaboration session. Lack of relevant mitigation solutions to alleviate lack of resource(s) during a collaboration session cause poor management of personnel resources when attempting to mitigate the lack of resource(s) available to the collaboration session.

### SUMMARY

This summary is provided to introduce a selection of concepts in a simplified form that are further described below in the Detailed Description. This summary is not intended to exclusively identify key features or essential features of the claimed subject matter, nor is it intended as an aid in determining the scope of the claimed subject matter.

Embodiments are directed to mitigation of an absence of a skill input during a collaboration session. A collaboration service, according to embodiments, may initiate operations to mitigate the absence of the skill input upon detecting a demand for the skill input associated with a collaboration session based on a behavior analysis of participant(s) of the collaboration session. A multi-level search may be performed for a person capable of providing the skill input. Upon locating the person capable of providing the skill input, a contact option for the person may be identified. The contact option for the person may be provided to the collaboration session.

These and other features and advantages will be apparent from a reading of the following detailed description and a review of the associated drawings. It is to be understood that both the foregoing general description and the following detailed description are explanatory and do not restrict aspects as claimed.

### BRIEF DESCRIPTION OF THE DRAWINGS

FIG. 1 is a conceptual diagram illustrating examples of mitigating an absence of a skill input during a collaboration session, according to embodiments;

FIG. 2 is a display diagram illustrating example components of a collaboration service that mitigates an absence of a skill input during a collaboration session, according to embodiments;

FIG. 3 is a display diagram illustrating components of a scheme to mitigate an absence of a skill input during a collaboration session, according to embodiments;

FIG. 4 is a display diagram illustrating a mitigation of an absence of a skill input during a collaboration session by locating a person and/or a content capable of providing the skill input, according to embodiments;

FIG. 5 is a simplified networked environment, where a system according to embodiments may be implemented;

FIG. 6 is a block diagram of an example computing device, which may be used to mitigate an absence of a skill input during a collaboration session, according to embodiments; and

FIG. 7 is a logic flow diagram illustrating a process for mitigating an absence of a skill input during a collaboration session, according to embodiments.

### DETAILED DESCRIPTION

As briefly described above, a collaboration service may mitigate an absence of a skill input during a collaboration session. In an example scenario, the collaboration service may detect a demand for the skill input associated with the collaboration session based on a behavior analysis of participant(s) of the collaboration session. The behavior analysis may include monitoring of a behavior of participant(s) associated with the collaboration session. Gesture based input, a voice based input, and/or a manual content input by the participant(s) may be monitored to detect a stress pattern associated with the collaboration session. The demand for the skill input may be inferred from the stress pattern.

A multi-level search for a person and/or a content capable of providing the skill input may be performed. The multi-level search may query internal and/or external personnel information and/or content provider(s) to locate the person and/or the content capable of providing the skill input.

Upon locating the person capable of providing the skill input, a contact option for the person may be identified. The contact option may be provided to the collaboration session. Upon locating the content capable of providing the skill input, the content may be provided to the collaboration session.

“Skill input” as used herein refers to, among other things, an expertise, a knowledge, and/or an information that are an attribute of a person determined to be needed for a collaboration session. “Skill input” may also refer to knowledge or information that may be found at a networked resource. For example, needed information may be determined based on analyses during the collaboration session as described herein, retrieved from a networked resource such as the Internet, and provided to the collaboration session as a document, video, or audio (e.g., read by a voice or virtual assistant).

A collaboration session as used herein may include an online conference with one or more of audio, video, email, messaging, data sharing, and/or application sharing components. In some examples, the collaboration session may include whiteboard sharing, where a smart whiteboard or a capture device associated with a whiteboard may capture notations on the whiteboard and make them part of the collaboration session. Thus, need for skill input may be determined and skill input provided for content provided through the whiteboard as well.

In the following detailed description, references are made to the accompanying drawings that form a part hereof, and in which are shown by way of illustrations, specific embodiments, or examples. These aspects may be combined, other aspects may be utilized, and structural changes may be made without departing from the spirit or scope of the present disclosure. The following detailed description is therefore not to be taken in a limiting sense, and the scope of the present invention is defined by the appended claims and their equivalents.

While some embodiments will be described in the general context of program modules that execute in conjunction with an application program that runs on an operating system on a personal computer, those skilled in the art will recognize that aspects may also be implemented in combination with other program modules.

Generally, program modules include routines, programs, components, data structures, and other types of structures that perform particular tasks or implement particular abstract data types. Moreover, those skilled in the art will appreciate that embodiments may be practiced with other computer system configurations, including hand-held devices, multiprocessor systems, microprocessor-based or programmable consumer electronics, minicomputers, mainframe computers, and comparable computing devices. Embodiments may also be practiced in distributed computing environments where tasks are performed by remote processing devices that are linked through a communications network. In a distributed computing environment, program modules may be located in both local and remote memory storage devices.

Some embodiments may be implemented as a computer-implemented process (method), a computing system, or as an article of manufacture, such as a computer program product or computer readable media. The computer program product may be a computer storage medium readable by a computer system and encoding a computer program that comprises instructions for causing a computer or computing system to perform example process(es). The computer-readable storage medium is a computer-readable memory device. The computer-readable storage medium can for example be implemented via one or more of a volatile computer memory, a non-volatile memory, a hard drive, a flash drive, a floppy disk, or a compact disk, and comparable hardware media.

Throughout this specification, the term “platform” may be a combination of software and hardware components for mitigating an absence of a skill input during a collaboration session. Examples of platforms include, but are not limited to, a hosted service executed over a plurality of servers, an application executed on a single computing device, and comparable systems. The term “server” generally refers to a computing device executing one or more software programs typically in a networked environment. However, a server may also be implemented as a virtual server (software programs) executed on one or more computing devices viewed as a server on the network. More detail on these technologies and example operations is provided below.

A computing device, as used herein, refers to a device comprising at least a memory and a processor that includes a desktop computer, a laptop computer, a tablet computer, a smart phone, a vehicle mount computer, or a wearable computer. A memory may be a removable or non-removable component of a computing device configured to store one or more instructions to be executed by one or more processors. A processor may be a component of a computing device coupled to a memory and configured to execute programs in conjunction with instructions stored by the memory. A file is any form of structured data that is associated with audio, video, or similar content. An operating system is a system configured to manage hardware and software components of a computing device that provides common services and applications. An integrated module is a component of an application or service that is integrated within the application or service such that the application or service is configured to execute the component. A computer-readable memory device is a physical computer-readable storage medium implemented via one or more of a volatile computer memory, a non-volatile memory, a hard drive, a flash drive, a floppy disk, or a compact disk, and comparable hardware media that includes instructions thereon to automatically save content to a location. A user experience—a visual display associated with an application or service through which a user interacts with the application or service. A user action refers to an interaction between a user and a user experience of an application or a user experience provided by a service that includes one of touch input, gesture input, voice command, eye tracking, gyroscopic input, pen input, mouse input, and keyboards input. An application programming interface (API) may be a set of routines, protocols, and tools for an application or service that enable the application or service to interact or communicate with one or more other applications and services managed by separate entities.

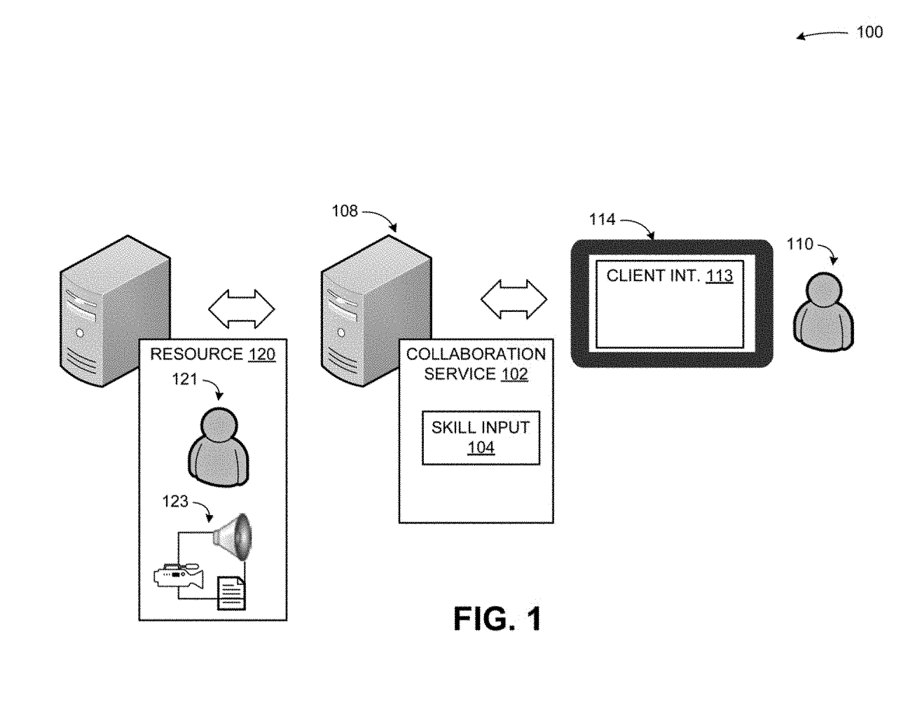

FIG. 1 is a conceptual diagram illustrating examples of mitigating an absence of a skill input during a collaboration session, according to embodiments.

In a diagram 100, a server 108 may execute (or provide) a collaboration service 102. The server 108 may include a physical server providing service(s) and/or application(s) to client devices. A service (such as the collaboration service 102) may include an application performing operations in relation to a client application and/or a subscriber, among others. The server 108 may include and/or is part of a workstation, a data warehouse, a data center, and/or a cloud based distributed computing source, among others.

The server 108 may execute the collaboration service 102. The collaboration service 102 may detect a demand for the skill input 104 associated with the collaboration session based on a behavior analysis of participant(s) of the collaboration session. The behavior analysis may include monitoring of a behavior of a participant 110 associated with the collaboration session. Gesture based input, a voice based input, and/or a manual content input by the participant 110 may be monitored to detect a stress pattern associated with the collaboration session. The demand for the skill input 104 may be inferred from the stress pattern. The stress pattern may be detected by analyzing the gesture based input, the voice based input, and/or the manual content input with scheme(s) to recognize expression patterns associated with the participant 110.

A multi-level search for a person 121 and/or a content 123 capable of providing the skill input 104 may be performed. The person 121 may include a co-worker, a colleague, a peer, and/or an expert, among others. The content 123 may include a textual, a graphic, an image, an animation, an audio, and/or a video based data, among others. The multi-level search may query a resource 120 (and others) based on the skill input 104. The resource 120 may include internal and/or external personnel information and/or content provider(s). The internal and/or external personnel information and/or content provider(s) may be queried to locate the person 121 and/or the content 123 capable of providing the skill input 104.

Upon locating the person 121 capable of providing the skill input 104, a contact option for the person 121 may be identified. Next, the contact option may be provided to the collaboration session. Upon locating the content 123 capable of providing the skill input 104, the content 123 may be provided to the collaboration session.

For example, the participant 110 may express an input that is monitored by the collaboration service 102. The input may be interpreted to express a stress pattern associated with an absence of other participant of the collaboration session. The other participant may be analyzed to identify a skill input associated with the other participant. The skill input may include an expertise, a knowledge, and/or an information, among others that are an attribute of the other participant. The resource 120 may be queried based on the skill input 104. A contact option for the person 121 and/or the content 123 capable of providing the skill input 104 may be located and provided to the collaboration session to mitigate the absence of the skill input 104 (associated with the other participant).

Furthermore, the collaboration service 102 may provide a client interface 113 rendered by a client device 114 to the participant 110. The participant 110 may participate in the collaboration session provided by the collaboration service 102 through the client interface 113. Alternatively, the collaboration service 102 may provide the collaboration session through a client interface rendered by an application (such as a communication and/or productivity application) executed by the client device 114.

The server 108 may communicate with the client device 114, and/or the resource 120, through a network. The network may provide wired or wireless communications between network nodes such as the client device 114, the server 108, and/or the resource 120, among others. Previous example(s) to mitigate an absence of the skill input 104 are not provided in a limiting sense. Alternatively, the collaboration service 102 may mitigate the absence of the skill input 104 as a desktop application, a workstation application, and/or a server application, among others. The client interface 113 may also include a client application interacting with the collaboration service 102.

The participant 110 may interact with the client interface 113 with a keyboard based input, a mouse based input, a voice based input, a pen based input, and a gesture based input, among others. The gesture based input may include one or more touch based actions such as a touch action, a swipe action, and a combination of each, among others.

While the example system in FIG. 1 has been described with specific components including the server 108, the collaboration service 102, embodiments are not limited to these components or system configurations and can be implemented with other system configuration employing fewer or additional components.

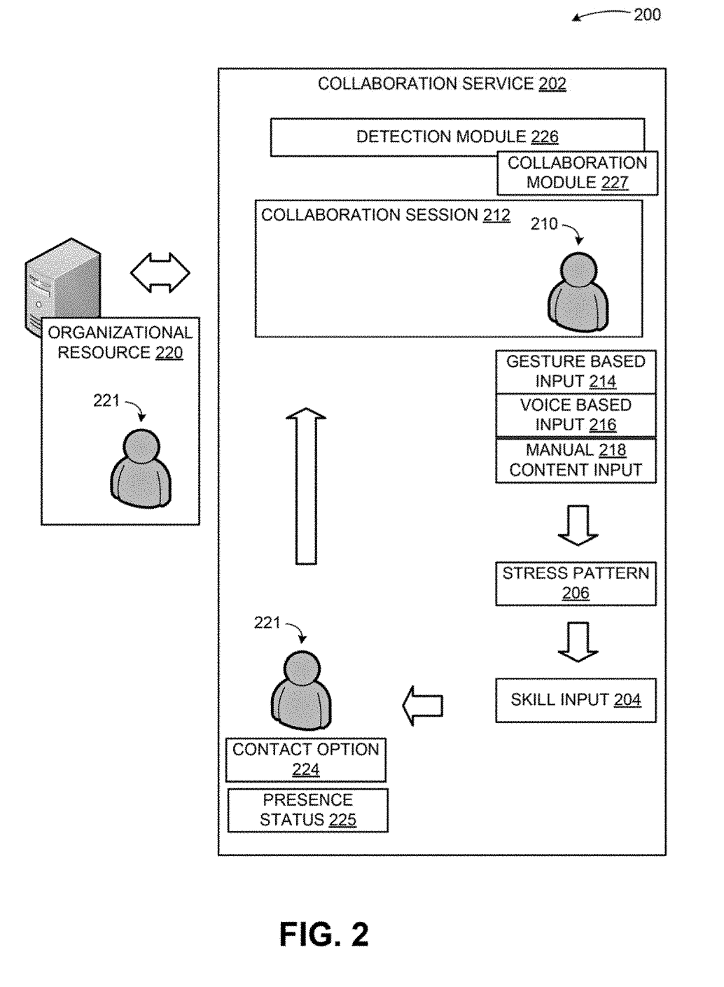

FIG. 2 is a display diagram illustrating example components of a collaboration service that mitigates an absence of a skill input during a collaboration session, according to embodiments.

As illustrated in diagram 200, a detection module 226 of a collaboration service 202 may detect a demand for a skill input 204 associated with a collaboration session 212. For example, the detection module 226 may monitor a gesture based input 214 of a participant 210 of the collaboration session 212 using a visual recognition scheme. The gesture based input 214 may be captured and provided by a client device rendering an interface of the collaboration session 212. Alternatively, the detection module 226 may delineate operation(s) associated with reception and/or management of the gesture based input 214 to a collaboration module 227. The collaboration module 227 may communicate with other device(s) associated with the collaboration session 212 to receive and/or monitor the gesture based input 214. The gesture based input 214 may also include a facial expression and/or a body based expression, among others.

For example, the detection module 226 may detect a facial expression and/or a hand gesture that expresses a frustration by the participant 210 regarding an absence of a knowledge, an information, and/or an expertise, among others associated with the collaboration session 212. The expression of frustration may be recognized as a stress pattern 206 by the detection module 226. The demand for the skill input 204 (such as the knowledge, the information, and/or the expertise, among others) may be inferred from the stress pattern 206. The stress pattern 206 may further be recognized from other properties associated with the gesture based input 214 such as a timing of the stress pattern 206, and/or a presence status of the participant 210 (or other participant(s)) associated with the skill input 204, among others.

The detection module 226 may also monitor a voice based input 216 using a voice recognition scheme and/or a manual content input 218 of the participant 210 using a text recognition scheme. The manual content input 218 may include a text based input and/or a graphics based input (such as a hand writing). The stress pattern 206 associated with the collaboration session 212 may be recognized from the voice based input 216 and/or the manual content input 218. The demand for the skill input 204 may also be recognized from the stress input.

For example, the participant 210 may provide a speech expression that indicates an absence of other participant during the collaboration session 212. The detection module 226 may analyze the other participant to recognize a knowledge, an information, and/or an expertise, among others as an attribute of the other participant. The knowledge, the information and/or the expertise, among others associated with the other participant may be designated as the skill input 204 that is absent during the collaboration session 212. Similarly, a manual content input 218 (such as a text based input and/or a hand-written input) during the collaboration session 212 may be recognized to express the stress pattern indicating the absence of the skill input 204 to be provided by the other participant.

In response to detecting the absence of the skill input 204, the detection module 226 may query an organizational resource 220 based on the skill input 204. An information associated with a person capable of providing the skill input 204 may be received from the organizational resource 220. For example, the organizational resource 220 may provide an information (such as an identification information, a contact option 224, and/or a presence status 225) associated with the person 221 who has a qualification that mitigates the absence of the skill input 204.

Alternatively, a combination of internal or external resources may be queried for the person 221 capable of providing the skill input 204. An example of the internal resource may include a personnel information provider. An example of the external resource may include a networking resource.

In another example scenario, a number of contact options associated with the person 221 may be identified from information associated with the person 221. The contact options may include various communication modalities that may be used to communicate with the person 221. The contact option 224 may be selected (from the contact options) to maximize a probability of establishing a communication session with the person 221. For example, the contact option 224 may include a presence status 225 associated with the person 221. If the presence status 225 designates the person as available the contact option 224 may be selected to establish a communication session with the person 221 (from the number of contact options associated with the person 221). The communication session may connect the person 221 to the collaboration session 212, as such, mitigating the absence of the skill input 204.

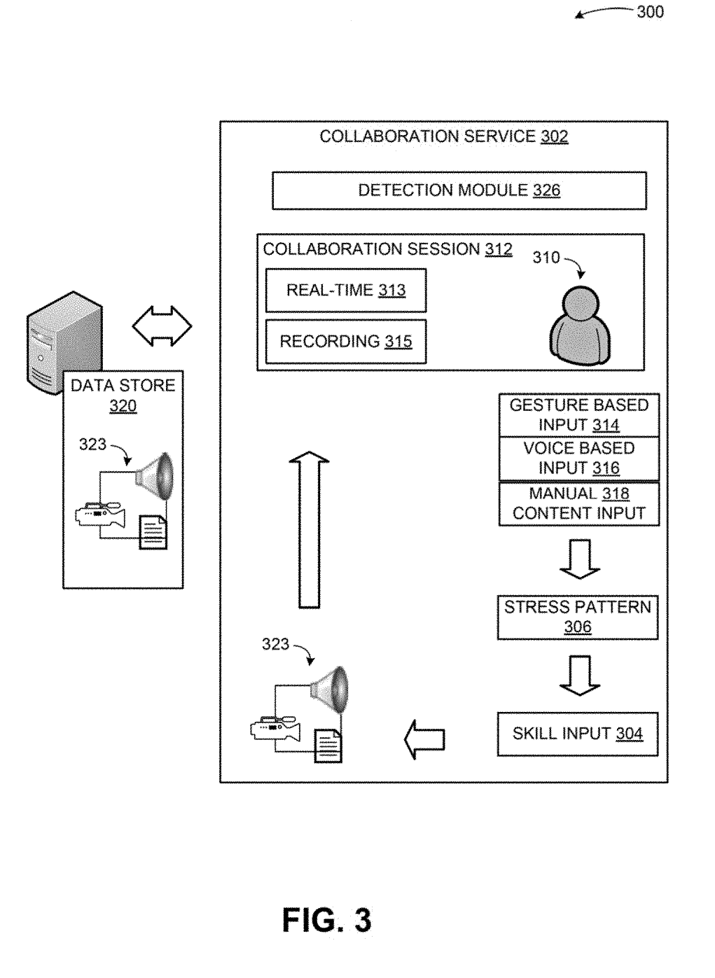

FIG. 3 is a display diagram illustrating components of a scheme to mitigate an absence of a skill input during a collaboration session, according to embodiments.

As shown in a diagram 300, a detection module 326 may perform a multi-level search for a content that matches a skill input 304 upon detecting a demand for the skill input 304 associated with a collaboration session 312. The detection module 326 may perform a multi-level search for the content 323 that matches the skill input 304. The content 323 may include a textual, a graphic, an image, an animation, an audio, and/or a video based data, among others. Upon locating the content 323, the content 323 may be provided to the collaboration session.

In an example scenario, the detection module 326 may analyze a gesture based input 314, a voice based input 316, and/or a manual content input 318 provided by a participant 310 of the collaboration session 312. A stress pattern 306 may be detected from the input(s). The stress pattern 306 may portray an absence of the skill input 304 in relation to the collaboration session 312. The skill input 304 may include a knowledge, an information, and/or an expertise, among others associated with the collaboration session 312. For example, the participant 310 may provide an expression that describes the absence of the skill input 304. The expression may include a property of the skill input 304 such as a title, a category, a description, an excerpt, and/or a subject, among other things. As such, the absence of the skill input 304 may be inferred from the stress pattern 306.

In another example scenario, a data store 320 associated with the skill input 304 may be identified. The data store 320 may be identified based on a designation associated with the skill input 304 such as a category, a classification, and/or a label, among others associated with the skill input 304. The designation may be used to locate the data store 320 that includes content associated with the category, the classification, and/or the label, among others. Next, a property and/or an information associated with the skill input 304 may be used to query the data store 320. Upon locating the content 323 that matches the skill input 304, the data store 320 may transmit the content 323. The detection module 326 may receive the content 323.

In an example scenario, the detection module 326 may identify an active status associated with the collaboration session 312. The participant 310 may be detected as actively collaborating with other participant(s) in the collaboration session 312. Upon confirming the active status, the content 323 may be provided to the collaboration session 312 in a real-time 313 for consumption (by the participant 310 and/or other participant(s)).

In another example scenario, the detection module 326 may identify an inactive status associated with the collaboration session 312. In such a scenario, the participant 310 may not engage in an active collaboration with other participant(s) in the collaboration session 312. Upon confirming the inactive status, the content 323 may be inserted into a recording 315 of the collaboration session 312. The content 323 may be inserted into a time in the recording 315 associated with an identification of the demand for the skill input. The identification of the demand for the skill input 304 may correlate with the detection of the absence of the skill input 304.

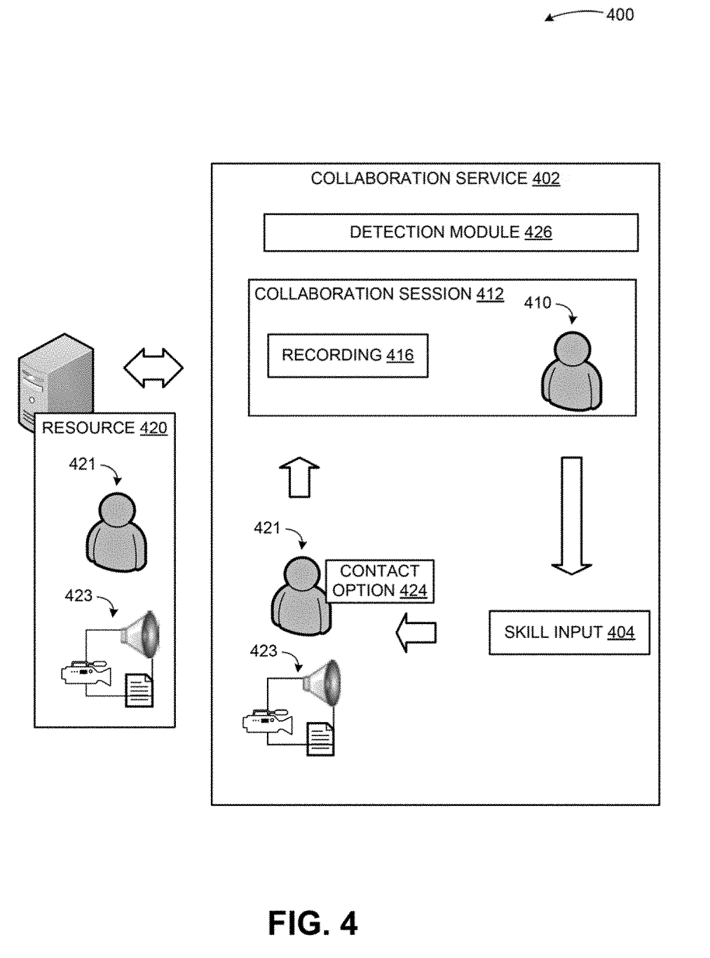

FIG. 4 is a display diagram illustrating a mitigation of an absence of a skill input during a collaboration session by locating a person and/or a content capable of providing the skill input, according to embodiments.

As shown in a diagram 400, a detection module 426 of a collaboration service 402 may locate and provide a contact option 424 of person 421 and/or a content 423 capable of providing a skill input 404 upon detecting an absence of the skill input 404 during the collaboration session 412. A resource 420 may be queried based on the skill input 404 by using a description, a classification, and/or a label, among other designation(s) associated with the skill input 404. Upon receiving the contact option associated with the person 421 and/or the content 423 from the resource 420 (or other resource(s)), the detection module 426 may provide the contact option 424 and/or the content 423 to the collaboration session 412.

In an example scenario, an invitation to join the collaboration session 412 may be transmitted to the person 421 using the contact option 424. Upon receiving an acceptance notification from the person 421, a communication session may be established to connect the person 421 to the collaboration session 412. The communication session may be established using the contact option 424.

In another example scenario, upon transmitting the invitation to join the collaboration session 412 to the person 421 (using the contact option 424), a rejection notification may be received to the invitation. Alternatively, a failure to respond to the invitation may be detected. In response to detecting a failure to respond or a rejection associated with the invitation, a recording 416 of the collaboration session 412 may be provided to the person 421. Furthermore, an input by the person 421 may be requested to mitigate the absence of the skill input 404.

In response to detecting a failure to contact the person 421, the detection module may locate other person capable of providing the skill input 404. Other contact option may be identified for the other person. The other contact option for the other person may be provided to the collaboration session 412.

As discussed above, the collaboration service may be employed to perform operations to mitigate an absence of a skill input during a collaboration session. An increased performance and efficiency improvement with the collaboration service 102 may occur as a result of detecting a demand for a skill input associated with a collaboration and mitigating the absence of the skill input by providing a contact option for a person and/or a content capable of providing the skill input. Additionally, performing a behavior analysis of participant(s) of the collaboration session to detect the absence of the skill input, by the collaboration service 102, may reduce processor load, increase processing speed, conserve memory, and reduce network bandwidth usage.

Embodiments, as described herein, address a need that arises from a lack of efficiency to mitigate an absence of a skill input during a collaboration session. The actions/operations described herein are not a mere use of a computer, but address results that are a direct consequence of software used as a service offered to large numbers of users and applications.

The example scenarios and schemas in FIG. 1 through 4 are shown with specific components, data types, and configurations. Embodiments are not limited to systems according to these example configurations. Mitigating an absence of a skill input during a collaboration session may be implemented in configurations employing fewer or additional components in applications and user interfaces. Furthermore, the example schema and components shown in FIG. 1 through 4 and their subcomponents may be implemented in a similar manner with other values using the principles described herein.

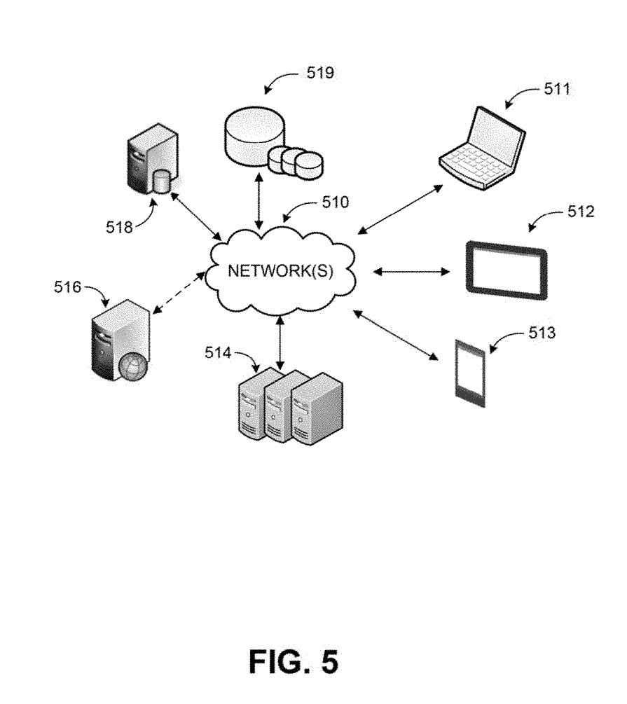

FIG. 5 is an example networked environment, where embodiments may be implemented. A collaboration service configured to mitigate an absence of a skill input may be implemented via software executed over one or more servers 514 such as a hosted service. The platform may communicate with client applications on individual computing devices such as a smart phone 513, a mobile computer 512, or desktop computer 511 (‘client devices’) through network(s) 510.

Client applications executed on any of the client devices 511-513 may facilitate communications via application(s) executed by servers 514, or on individual server 516. A collaboration service may detect a demand for a skill input associated with a collaboration session based on a behavior analysis of participant(s) of the collaboration session. A multi-level search may be performed for a person capable of providing the skill input. Upon locating the person capable of providing the skill input, a contact option for the person may be identified. The contact option for the person may be provided to the collaboration session. The collaboration service may store data associated with the collaboration session in data store(s) 519 directly or through database server 518.

Network(s) 510 may comprise any topology of servers, clients, Internet service providers, and communication media. A system according to embodiments may have a static or dynamic topology. Network(s) 510 may include secure networks such as an enterprise network, an unsecure network such as a wireless open network, or the Internet. Network(s) 510 may also coordinate communication over other networks such as Public Switched Telephone Network (PSTN) or cellular networks. Furthermore, network(s) 510 may include short range wireless networks such as Bluetooth or similar ones. Network(s) 510 provide communication between the nodes described herein. By way of example, and not limitation, network(s) 510 may include wireless media such as acoustic, RF, infrared and other wireless media.

Many other configurations of computing devices, applications, data sources, and data distribution systems may be employed to mitigate an absence of a skill input during a collaboration session. Furthermore, the networked environments discussed in FIG. 5 are for illustration purposes only. Embodiments are not limited to the example applications, modules, or processes.

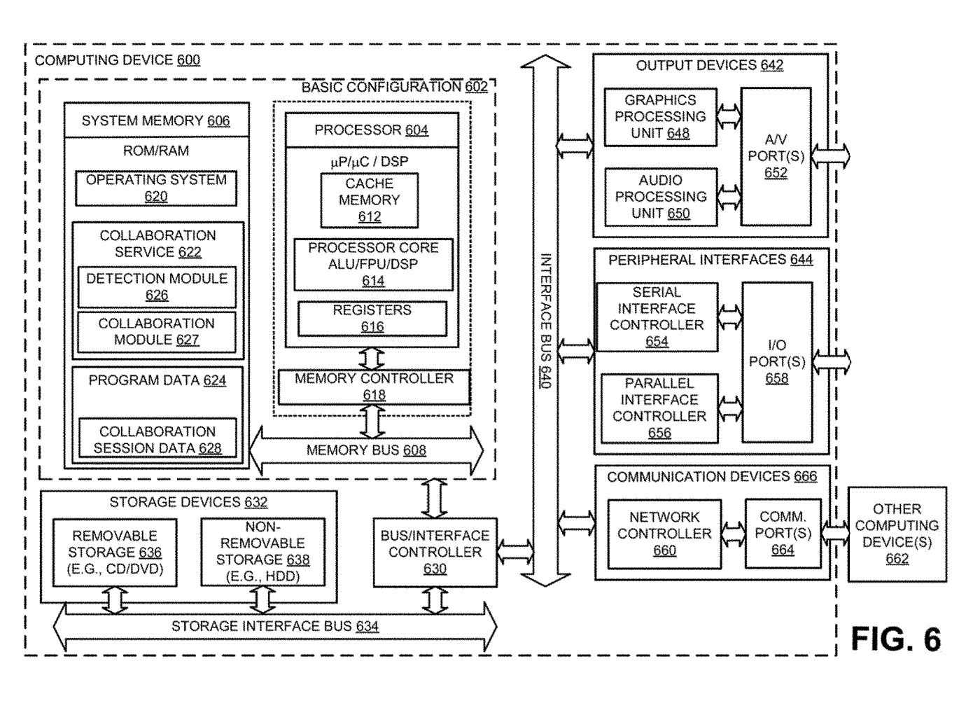

FIG. 6 is a block diagram of an example computing device, which may be used to mitigate an absence of a skill input during a collaboration session, according to embodiments.

For example, computing device 600 may be used as a server, desktop computer, portable computer, smart phone, special purpose computer, or similar device. In an example basic configuration 602, the computing device 600 may include one or more processors 604 and a system memory 606. A memory bus 608 may be used for communication between the processor 604 and the system memory 606. The basic configuration 602 may be illustrated in FIG. 6 by those components within the inner dashed line.

Depending on the desired configuration, the processor 604 may be of any type, including but not limited to a microprocessor (μP), a microcontroller (μC), a digital signal processor (DSP), or any combination thereof. The processor 604 may include one more levels of caching, such as a level cache memory 612, one or more processor cores 614, and registers 616. The example processor cores 614 may (each) include an arithmetic logic unit (ALU), a floating point unit (FPU), a digital signal processing core (DSP Core), a graphics processing unit (GPU), or any combination thereof. An example memory controller 618 may also be used with the processor 604, or in some implementations, the memory controller 618 may be an internal part of the processor 604.

Depending on the desired configuration, the system memory 606 may be of any type including but not limited to volatile memory (such as RAM), non-volatile memory (such as ROM, flash memory, etc.), or any combination thereof. The system memory 606 may include an operating system 620, a collaboration service 622, and a program data 624. The collaboration service 622 may include components such as a detection module 626 and a collaboration module 627. The detection module 626 and the collaboration module 627 may execute the processes associated with the collaboration service 622. The detection module 626 may detect a demand for the skill input associated with the collaboration session based on a behavior analysis of participant(s) of the collaboration session. A multi-level search may be performed for a person capable of providing the skill input. Upon locating the person capable of providing the skill input, a contact option for the person may be identified. The collaboration module 627 may provide the contact option for the person to the collaboration session.

Input to and output out of the collaboration service 622 may be transmitted through a communication device 666 that may be communicatively coupled to the computing device 600. The communication device 666 may provide wired and/or wireless communication. The program data 624 may also include, among other data, a collaboration session data 628, or the like, as described herein. The collaboration session data 628 may include information associated with participant(s), among others.

The computing device 600 may have additional features or functionality, and additional interfaces to facilitate communications between the basic configuration 602 and any desired devices and interfaces. For example, a bus/interface controller 630 may be used to facilitate communications between the basic configuration 602 and one or more data storage devices 632 via a storage interface bus 634. The data storage devices 632 may be one or more removable storage devices 636, one or more non-removable storage devices 638, or a combination thereof. Examples of the removable storage and the non-removable storage devices may include magnetic disk devices, such as flexible disk drives and hard-disk drives (HDDs), optical disk drives such as compact disk (CD) drives or digital versatile disk (DVD) drives, solid state drives (SSDs), and tape drives, to name a few. Example computer storage media may include volatile and nonvolatile, removable, and non-removable media implemented in any method or technology for storage of information, such as computer-readable instructions, data structures, program modules, or other data.

The system memory 606, the removable storage devices 636 and the non-removable storage devices 638 are examples of computer storage media. Computer storage media includes, but is not limited to, RAM, ROM, EEPROM, flash memory or other memory technology, CD-ROM, digital versatile disks (DVDs), solid state drives, or other optical storage, magnetic cassettes, magnetic tape, magnetic disk storage or other magnetic storage devices, or any other medium which may be used to store the desired information and which may be accessed by the computing device 600. Any such computer storage media may be part of the computing device 600.

The computing device 600 may also include an interface bus 640 for facilitating communication from various interface devices (for example, one or more output devices 642, one or more peripheral interfaces 644, and one or more communication devices 666) to the basic configuration 602 via the bus/interface controller 630. Some of the example output devices 642 include a graphics processing unit 648 and an audio processing unit 650, which may be configured to communicate to various external devices such as a display or speakers via one or more A/V ports 652. One or more example peripheral interfaces 644 may include a serial interface controller 654 or a parallel interface controller 656, which may be configured to communicate with external devices such as input devices (for example, keyboard, mouse, pen, voice input device, touch input device, etc.) or other peripheral devices (for example, printer, scanner, etc.) via one or more I/O ports 658. An example of the communication device(s) 666 includes a network controller 660, which may be arranged to facilitate communications with one or more other computing devices 662 over a network communication link via one or more communication ports 664. The one or more other computing devices 662 may include servers, computing devices, and comparable devices.

The network communication link may be one example of a communication media. Communication media may typically be embodied by computer readable instructions, data structures, program modules, or other data in a modulated data signal, such as a carrier wave or other transport mechanism, and may include any information delivery media. A “modulated data signal” may be a signal that has one or more of its characteristics set or changed in such a manner as to encode information in the signal. By way of example, and not limitation, communication media may include wired media such as a wired network or direct-wired connection, and wireless media such as acoustic, radio frequency (RF), microwave, infrared (IR) and other wireless media. The term computer readable media as used herein may include both storage media and communication media.

The computing device 600 may be implemented as a part of a specialized server, mainframe, or similar computer, which includes any of the above functions. The computing device 600 may also be implemented as a personal computer including both laptop computer and non-laptop computer configurations. Additionally, the computing device 600 may include specialized hardware such as an application-specific integrated circuit (ASIC), a field programmable gate array (FPGA), a programmable logic device (PLD), and/or a free form logic on an integrated circuit (IC), among others.

Example embodiments may also include methods to mitigate an absence of a skill input during a collaboration session. These methods can be implemented in any number of ways, including the structures described herein. One such way may be by machine operations, of devices of the type described in the present disclosure. Another optional way may be for one or more of the individual operations of the methods to be performed in conjunction with one or more human operators performing some of the operations while other operations may be performed by machines. These human operators need not be collocated with each other, but each can be only with a machine that performs a portion of the program. In other embodiments, the human interaction can be automated such as by pre-selected criteria that may be machine automated.

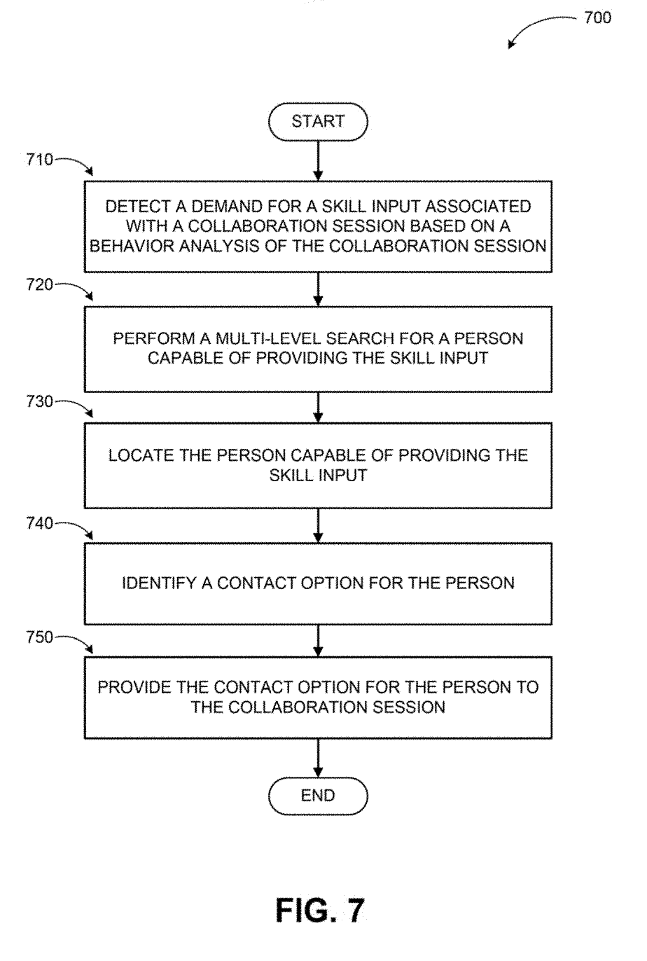

FIG. 7 is a logic flow diagram illustrating a process for mitigating an absence of a skill input during a collaboration session, according to embodiments. Process 700 may be implemented on a computing device, such as the computing device 600 or another system.

Process 700 begins with operation 710, where a collaboration service may detect a demand for the skill input associated with the collaboration session based on a behavior analysis of participant(s) of the collaboration session. The behavior analysis may include monitoring of a behavior of participant(s) associated with the collaboration session. At operation 720, a multi-level search for a person and/or a content capable of providing the skill input may be performed. The multi-level search may query internal and/or external personnel information and/or content provider(s) to locate the person and/or the content capable of providing the skill input.

At operation 730, the person (and/or the content) capable of providing the skill input may be located. At operation 740, a contact option for the person may be identified. The contact option (and/or the content) may be provided to the collaboration session at operation 750.

The operations included in process 700 is for illustration purposes. Mitigating an absence of a skill input during a collaboration session may be implemented by similar processes with fewer or additional steps, as well as in different order of operations using the principles described herein. The operations described herein may be executed by one or more processors operated on one or more computing devices, one or more processor cores, specialized processing devices, and/or special purpose processors, among other examples.

According to examples, a means for mitigating an absence of a skill input during a collaboration session is described. The means may include a means for detecting a demand for the skill input associated with the collaboration session based on a behavior analysis of one or more participants of the collaboration session; a means for performing a multi-level search for a person capable of providing the skill input; and a means for identifying a contact option for the person, and providing the contact option for the person to the collaboration session upon locating the person capable of providing the skill input.

According to some examples, a method executed on a computing device to mitigate an absence of a skill input during a collaboration session is described. The method may include detecting a demand for the skill input associated with the collaboration session based on a behavior analysis of one or more participants of the collaboration session; performing a multi-level search for a person capable of providing the skill input; and upon locating the person capable of providing the skill input, identifying a contact option for the person, and providing the contact option for the person to the collaboration session.

According to other examples, detecting the demand for the skill input associated with the collaboration session may include monitoring a gesture based input of a participant of the collaboration session using a visual recognition scheme; recognizing a stress pattern associated with the collaboration session from the gesture based input of the participant; and inferring the demand for the skill input from the stress pattern. The gesture based input may include one or more of a facial express and a body based expression. Detecting the demand for the skill input associated with the collaboration session may also include monitoring a voice based input of a participant of the collaboration session using a voice recognition scheme; recognizing a stress pattern associated with the collaboration session from the voice based input of the participant; and inferring the demand for the skill input from the stress pattern.

According to further examples, detecting the demand for the skill input associated with the collaboration session may include monitoring a manual content input of a participant of the collaboration session using a text recognition scheme; recognizing a stress pattern associated with the collaboration session from the manual content input of the participant; and inferring the demand for the skill input from the stress pattern. The manual content input may include one or more of a text based input and a graphics based input. Performing the multi-level search for the person capable of providing the skill input may include querying an organizational resource based on the skill input; and receiving an information associated with the person from the organizational resource.

According to some examples, performing the multi-level search for the person capable of providing the skill input may include querying a combination of internal and external networked resources for the person capable of providing the skill input; and receiving an information associated with the person from the combination of internal and external networked resources. The method may also include identifying a plurality of contact options associated with the person from an information associated with the person; and selecting one of the plurality of contact options for the person, where the selected contact option includes a presence status associated with the person. The presence status may designate the person as available.

According to other examples, a server configured to mitigate an absence of a skill input during a collaboration session is described. The server may include a communication device configured to facilitate communication between a collaboration service and one or more client devices; a memory configured to store instructions; and a processor coupled to the memory and the communication device, the processor executing the collaboration service in conjunction with the instructions stored in the memory. The collaboration service may include a detection module configured to detect a demand for the skill input associated with the collaboration session based on a behavior analysis of one or more of participants the collaboration session; perform a multi-level search for a person capable of providing the skill input; locate the person capable of providing the skill input; and identify a contact option for the person. The collaboration service may also include a collaboration module configured to provide, through the communication device, the contact option for the person to the collaboration session.

According to some examples, the collaboration module may be further configured to transmit, through the communication device, an invitation to join the collaboration session to the person using the contact option; receive, through the communication device, an acceptance notification from the person; and establish, through the communication device, a communication session to connect the person to the collaboration session. The collaboration module may be further configured to transmit, through the communication device, an invitation to join the collaboration session to the person using the contact option; and receive, through the communication device, a rejection notification to the invitation or detect a failure to respond to the invitation.

According to other examples, the collaboration module may be further configured to provide, through the communication device, a recording of the collaboration session using the contact option to the person; and request, through the communication device, an input by the person. The detection module may be further configured to detect a failure to contact the person; locate other person capable of providing the skill input; identify other contact option for the other person; and instruct the collaboration module to provide the other contact option for the other person to the collaboration session.

According to further examples, a computer-readable memory device with instructions stored thereon to mitigate an absence of a skill input during a collaboration session is described. The instructions may include detecting a demand for the skill input associated with the collaboration session based on a behavior analysis of one or more participants of the collaboration session; performing a multi-level search for a content that matches the skill input; locating the content; and providing the content to the collaboration session.

According to yet other examples, the instructions may further include identifying a data store associated with the skill input; querying the data store based on the skill input; and receiving the content from the data store. The instructions may also include identifying an active status associated with the collaboration session; and providing the content to the collaboration session in real-time. The instructions may further include identifying an inactive status associated with the collaboration session; and inserting the content to a recording of the collaboration session. The content may be inserted into a time in the recording associated with an identification of the demand for the skill input.

The above specification, examples and data provide a complete description of the manufacture and use of the composition of the embodiments. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims and embodiments.

What is claimed is:

1. A method executed on a computing device to mitigate an absence of a skill input during a collaboration session, the method comprising:
detecting a demand for the skill input associated with the collaboration session based on a behavior analysis of one or more participants of the collaboration session;
performing a multi-level search for a person capable of providing the skill input; and
upon locating the person capable of providing the skill input, identifying a contact option for the person, and providing the contact option for the person to the collaboration session.

2. The method of claim 1, wherein detecting the demand for the skill input associated with the collaboration session comprises:
monitoring a gesture based input of a participant of the collaboration session using a visual recognition scheme;
recognizing a stress pattern associated with the collaboration session from the gesture based input of the participant; and
inferring the demand for the skill input from the stress pattern.

3. The method of claim 2, wherein the gesture based input includes one or more of a facial express and a body based expression.

4. The method of claim 1, wherein detecting the demand for the skill input associated with the collaboration session comprises:
monitoring a voice based input of a participant of the collaboration session using a voice recognition scheme;
recognizing a stress pattern associated with the collaboration session from the voice based input of the participant; and
inferring the demand for the skill input from the stress pattern.

5. The method of claim 1, wherein detecting the demand for the skill input associated with the collaboration session comprises:
monitoring a manual content input of a participant of the collaboration session using a text recognition scheme;
recognizing a stress pattern associated with the collaboration session from the manual content input of the participant; and
inferring the demand for the skill input from the stress pattern.

6. The method of claim 5, wherein the manual content input includes one or more of a text based input and a graphics based input.

7. The method of claim 1, wherein performing the multi-level search for the person capable of providing the skill input comprises:
querying an organizational resource based on the skill input; and
receiving an information associated with the person from the organizational resource.

8. The method of claim 1, wherein performing the multi-level search for the person capable of providing the skill input comprises:
querying a combination of internal and external networked resources for the person capable of providing the skill input; and
receiving an information associated with the person from the combination of internal and external networked resources.

9. The method of claim 1, further comprising:
identifying a plurality of contact options associated with the person from an information associated with the person; and
selecting one of the plurality of contact options for the person, wherein the selected contact option includes a presence status associated with the person.

10. The method of claim 9, wherein the presence status designates the person as available.

11. A server configured to mitigate an absence of a skill input during a collaboration session, the server comprising:
a communication device configured to facilitate communication between a collaboration service and one or more client devices;
a memory configured to store instructions; and
a processor coupled to the memory and the communication device, the processor executing the collaboration service in conjunction with the instructions stored in the memory, wherein the collaboration service includes:
a detection module configured to:
detect a demand for the skill input associated with the collaboration session based on a behavior analysis of one or more of participants the collaboration session;
perform a multi-level search for a person capable of providing the skill input;
locate the person capable of providing the skill input:
identify a contact option for the person; and
a collaboration module configured to:
provide, through the communication device, the contact option for the person to the collaboration session.

12. The server of claim 11, wherein the collaboration module is further configured to:
transmit, through the communication device, an invitation to join the collaboration session to the person using the contact option;
receive, through the communication device, an acceptance notification from the person; and
establish, through the communication device, a communication session to connect the person to the collaboration session.

13. The server of claim 11, wherein the collaboration module is further configured to:
transmit, through the communication device, an invitation to join the collaboration session to the person using the contact option; and
one of:
receive, through the communication device, a rejection notification to the invitation; and
detect a failure to respond to the invitation.

14. The server of claim 13, wherein the collaboration module is further configured to:
provide, through the communication device, a recording of the collaboration session using the contact option to the person; and
request, through the communication device, an input by the person.

15. The server of claim 11, wherein the detection module is further configured to:
detect a failure to contact the person;
locate other person capable of providing the skill input;
identify other contact option for the other person; and
instruct the collaboration module to provide the other contact option for the other person to the collaboration session.

16. A computer-readable memory device with instructions stored thereon to mitigate an absence of a skill input during a collaboration session, the instructions comprising:
detecting a demand for the skill input associated with the collaboration session based on a behavior analysis of one or more participants of the collaboration session;
performing a multi-level search for a content that matches the skill input;
locating the content; and
providing the content to the collaboration session.

17. The computer-readable memory device of claim 16, wherein the instructions further comprise:
identifying a data store associated with the skill input;
querying the data store based on the skill input; and
receiving the content from the data store.

18. The computer-readable memory device of claim 16, wherein the instructions further comprise:
identifying an active status associated with the collaboration session; and
providing the content to the collaboration session in real-time.

19. The computer-readable memory device of claim 16, wherein the instructions further comprise:
identifying an inactive status associated with the collaboration session; and
inserting the content to a recording of the collaboration session.

20. The computer-readable memory device of claim 19, wherein the content is inserted into a time in the recording associated with an identification of the demand for the skill input.
